(19) United States
(12) Patent Application Publication
(10) Pub. No.: US 2008/0076518 A1
(43) Pub. Date: Mar. 27, 2008

(54) SLOT MACHINE WITH PAYOUT ACCORDING TO SYMBOLS IN GROUPED AREAS AND PLAYING METHOD THEREOF

(75) Inventor: Kazumasa YOSHIZAWA, Tokyo (JP)

Correspondence Address: OBLON, SPIVAK, MCCLELLAND MAIER & NEUSTADT, P.C., 1940 DUKE STREET, ALEXANDRIA, VA, 22314, US

(73) Assignee: ARUZE CORP., Koto-ku (JP)

(21) Appl. No.: 11/851,098

(22) Filed: Sep. 6, 2007

(30) Foreign Application Priority Data
Sep. 21, 2006 (JP) P2006-255743

(51) Int. Cl. A63F 13/00

(52) U.S. Cl. 463/20; 463/16

(57) ABSTRACT

A slot machine includes: a liquid crystal display unit which has a plurality of defined areas provided in a matrix pattern, and which stops symbols after the symbols are scrolled in the respective defined areas; and a controller which sets defined-area groups including the plurality of defined areas, which counts, for each of the defined-area groups, any one of the number of bonus games in which a “JOKER” symbol is stopped in each of the defined-area groups and the number of the “JOKER” symbols stopped in execution of the bonus game to which a shift is made from a basic game, and which changes a payout to a player according to the count value for a specific defined-area group.

### CROSS REFERENCE TO RELATED APPLICATIONS

This application is based upon and claims the benefit of priority from the prior Japanese Patent Application No. 2006-255743, filed on Sep. 21, 2006, the entire contents of which are incorporated herein by reference.

### BACKGROUND OF THE INVENTION

1. Field of the Invention

The present invention relates to a slot machine for playing a game using game media, such as coins, and a method for playing the slot machine.

2. Description of the Related Art

In a facility having a slot machine placed therein, it has heretofore been possible to play a game by throwing various game media, such as coins and cash, into the slot machine. As disclosed in U.S. Pat. No. 6,960,133, each slot machine provides a payout according to a winning combination established in the course of the game.

A relevant slot machine is described in Australian Patent No. PQ6296. In Australian Patent No. PQ6296, it is proposed that, as a secondary game to which a shift is made when a basic game is executed, a free game is executed, in which an effect of superimposing character images on symbols displayed in display areas of a video reel is performed.

However, since the slot machine described in Australian Patent No. PQ6296 is less entertaining, proposal of a slot machine being more entertaining has been desired.

### SUMMARY OF THE INVENTION

The present invention was made to solve the problems described above. It is an object of the present invention to provide a slot machine which can heighten expectations of a player and can also perform entertaining effect display, and to provide a method for playing the slot machine.

The first aspect of the present invention is a slot machine comprising: a display having a plurality of defined areas in a matrix pattern consisting of a plurality of columns and rows, and adapted to rearrange symbols arranged in the respective defined areas; and a controller configured to (a) set a plurality of defined-area groups each including at least one of the plurality of defined areas, (b) count, for each of the defined-area groups, any one of the number of bonus games in which a specific symbol is rearranged in the defined-area groups and the number of specific symbols rearranged in the defined-area groups, in bonus games shifted from a basic game, and (c) provide a payout to a player according to the counted number for a specific defined-area group among the defined-area groups.

According to the first aspect of the present invention, in execution of a bonus game, a plurality of defined-area groups including the plurality of defined areas are set. Thereafter, in execution of more than one bonus game, the number of bonus games in which a specific symbol is rearranged and displayed in each of the defined-area groups or the number of the specific symbols rearranged in each of the defined-area groups in more than one bonus game is counted. Subsequently, a payout (an award) to be provided to a player is set so as to vary according to the counted number for a specific defined-area group selected from the plurality of defined-area groups.

Accordingly, it is possible to allow the player to have expectations for rearrangement and display of the specific symbol in the specific defined-area group. Thus, the slot machine becomes more entertaining.

The second aspect of the present invention is a slot machine comprising: a display having a plurality of defined areas in a matrix pattern consisting of a plurality of columns and rows, and adapted to rearrange symbols arranged in the respective defined areas; and a controller configured to (a) set a plurality of defined-area groups each including at least one of the plurality of defined areas, (b) count, for each of the defined-area groups, any one of the number of bonus games in which a specific symbol is rearranged in the defined-area groups and the number of the specific symbols rearranged in the defined-area groups, in bonus games shifted from a basic game, (c) determine an order in which each of the counted numbers reaches a predetermined number for the defined-area groups, and (d) provide a higher payout to a player when the order for a specific defined-area group among the defined-area groups is higher.

According to the second aspect of the present invention, in execution of a bonus game, a plurality of defined-area groups including the plurality of defined areas are set. Thereafter, in execution of more than one bonus game, the number of bonus games in which a specific symbol is rearranged and displayed in each of the defined-area groups or the number of the specific symbols rearranged in each of the defined-area groups in more than one bonus game is counted. Thereafter, the defined-area groups are ranked from the one for which the counted number first reaches a predetermined number. A payout to be provided to a player is set higher as a specific defined-area group selected from the plurality of defined-area groups is ranked in a higher place.

Accordingly, it is possible to allow the player to have interest in that a larger number of specific symbols will be stopped in the defined areas included in the specific defined-area group. Thus, the slot machine becomes more entertaining.

The third aspect of the present invention is a slot machine comprising: a display having a plurality of defined areas in a matrix pattern consisting of a plurality of columns and rows, and adapted to rearrange symbols arranged in the respective defined areas; and a controller configured to (a) set a plurality of defined-area groups each including at least one of the plurality of defined areas, (b) count, for each of the defined-area groups, any one of the number of bonus games in which a specific symbol is rearranged in the defined-area groups and the number of specific symbols rearranged in the defined-area groups, in bonus games shifted from a basic game, (c) set at least one of the defined areas as a high-multiplying-factor defined area, (d) set a counted number for the defined-area group including the high-multiplying-factor defined area so as to be larger than that in a normal time when the specific symbol is rearranged in the high-multiplying-factor defined area, (e) determine an order in which each of the counted numbers reaches a predetermined number for the defined-area groups, and (f) provide a higher payout to a player when the order for a specific defined-area group among the defined-area groups is higher.

According to the third aspect of the present invention, in execution of a bonus game, a plurality of defined-area groups including the plurality of defined areas are set. Thereafter, in execution of more than one bonus game, the number of bonus games in which a specific symbol is rearranged in each of the defined-area groups or the number of the specific symbols rearranged in each of the defined-area groups in more than one bonus game is counted. Moreover, some of the plurality of defined areas are set as high-multiplying-factor defined areas. Furthermore, when the specific symbol is rearranged and displayed in one of the high-multiplying-factor defined area, a counted number for the defined-area group including the high-multiplying-factor defined area is set to be larger than that in a normal time. Thereafter, the respective defined-area groups are ranked from the one for which the counted number first reaches a predetermined number. A payout to be provided to a player is set higher as a specific defined-area group selected from the plurality of defined-area groups is ranked in a higher place.

Accordingly, it is possible to allow the player to have interest in whether or not more specific symbols will be stopped in the defined areas included in the specific defined-area group and whether or not the specific symbol will be stopped in the high-multiplying-factor defined area. Thus, the slot machine becomes more entertaining.

### BRIEF DESCRIPTION OF THE DRAWINGS

FIG. 1 is a flowchart schematically showing operations related to a method for playing a slot machine according to an embodiment of the present invention.

FIG. 2 is a perspective view showing an external appearance of the slot machine according to the embodiment of the present invention.

FIG. 3 is an explanatory view showing symbols displayed on a rotating reel in the slot machine according to the embodiment of the present invention.

FIG. 4 is an explanatory view showing a payout table for determining a payout amount in the slot machine according to the embodiment of the present invention.

FIG. 5 is a block diagram showing an internal configuration of the slot machine according to the embodiment of the present invention.

FIG. 6 is a flowchart showing game execution processing executed in the slot machine according to the embodiment of the present invention.

FIG. 7 is a flowchart showing symbol determination processing executed in the slot machine according to the embodiment of the present invention.

FIG. 8 is a flowchart showing bonus game processing executed in the slot machine according to the embodiment of the present invention.

FIG. 9 is an explanatory view showing a display example in the slot machine according to the embodiment of the present invention.

FIG. 10 is an explanatory view showing a display example in a slot machine according to a modified example of the embodiment of the present invention.

FIG. 11 is an explanatory view showing defined areas in the slot machine according to the embodiment of the present invention.

### DETAILED DESCRIPTION OF THE EMBODIMENT

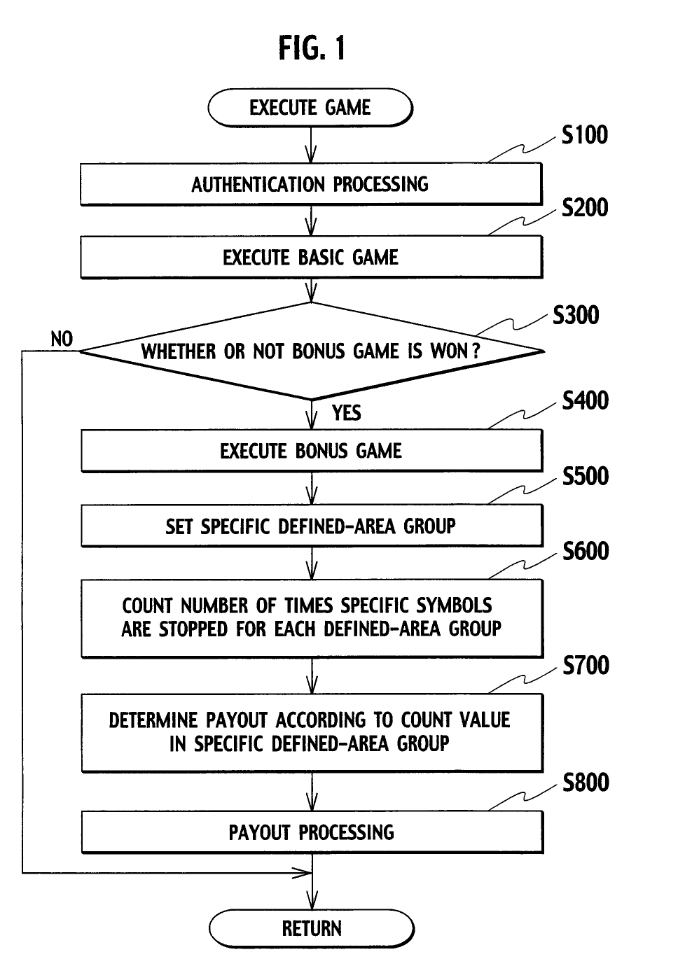

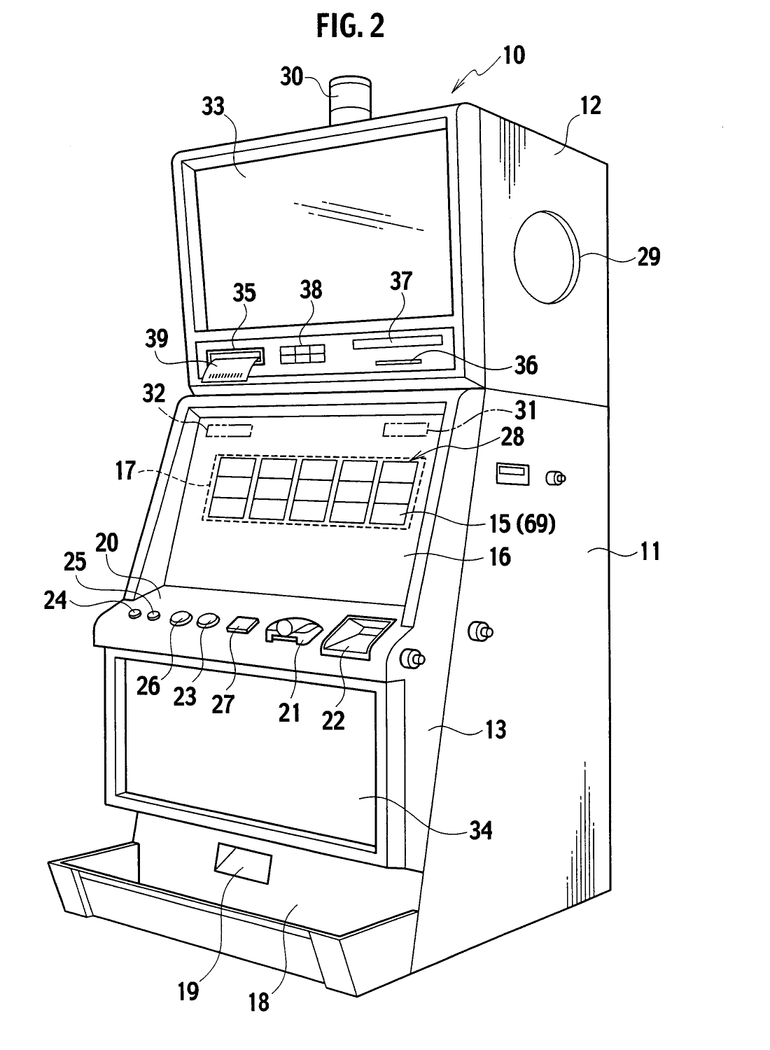

With reference to the flowchart shown in FIG. 1 and a perspective view shown in FIG. 2, description will be given below of schematic operations of the slot machine and the method for playing the slot machine according to the embodiment of the present invention.

In the slot machine according to the embodiment of the present invention, when a power is turned on to start the slot machine, authentication processing is first performed (Step S100). In the authentication processing, initial checking before a basic game is started is carried out, such as whether or not a program for operating a system is normally run and whether or not the program has been altered.

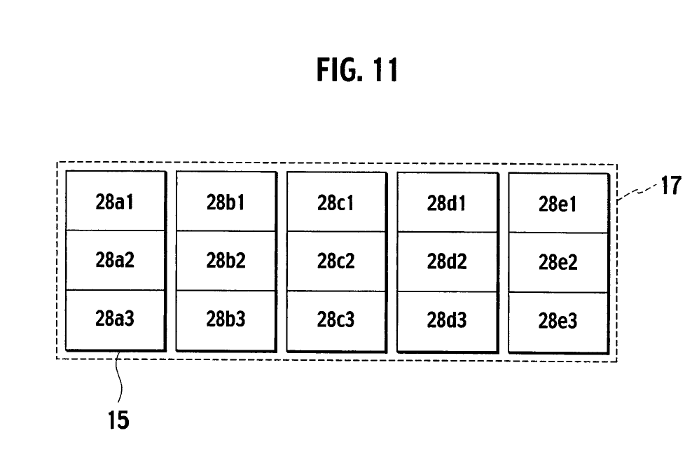

Next, the basic game is executed (Step S200). In the basic game, when a spin button 23 is pressed in a state where a desired number of credits are bet by throwing coins into a coin receiving port 21 or the like, scrolling of symbols is started in 5 columns×3 rows, a total of 15 defined areas (28a1 to 28e3) provided inside of a display window 15 in the front surface of a cabinet 11. Thereafter, the symbols are stopped (rearranged and displayed). Here, suffixes “a” to “e” attached to the defined areas 28 represent columns of the respective defined areas 28 provided in a matrix pattern, and suffixes “1” to “3” attached thereto represent rows (see FIG. 11).

On the front side of the display window 15, a touch panel is provided, which is divided into 5 columns×3 rows so as to correspond to the respective defined areas 28. Accordingly, when a player touches any of the fifteen defined areas 28 shown in FIG. 11 while the touch panel is activated, the touched defined area 28 is detected.

Next, it is determined whether or not a bonus game is won (Step S300). For example, in the case where five defined areas in the top row (28a1 to 28e1), five defined areas in the middle row (28a2 to 28e2) and five defined areas in the bottom row (28a3 to 28e3) among the three rows of defined areas are set as paylines, a shift is made from the basic game to the bonus game when, for example, “APPLE” symbols to be a bonus trigger are stopped in any of the paylines.

When the bonus trigger is established, the bonus game is executed, for which an upper limit of the number of executions is set (Step S400). In the bonus game, the fifteen defined areas (28a1 to 28e3) are divided into several defined-area groups. For example, the defined areas are divided into defined-area groups for each column, in other words, into five columns of defined-area groups including a defined-area group A (28a1 to 28a3), a defined-area group B (28b1 to 28b3), a defined-area group C (28c1 to 28c3), a defined-area group D (28d1 to 28d3) and a defined-area group E (28e1 to 28e3).

Next, a specific defined-area group is selected from the five columns of defined-area groups A to E (Step S500). Although one defined-area group is to be selected in this embodiment, the present invention is not limited thereto. The specific defined-area group may be randomly selected from the five columns of defined-area groups. Alternatively, a desired defined-area group may be selected by the player operating the touch panel or the like (selection by an external input).

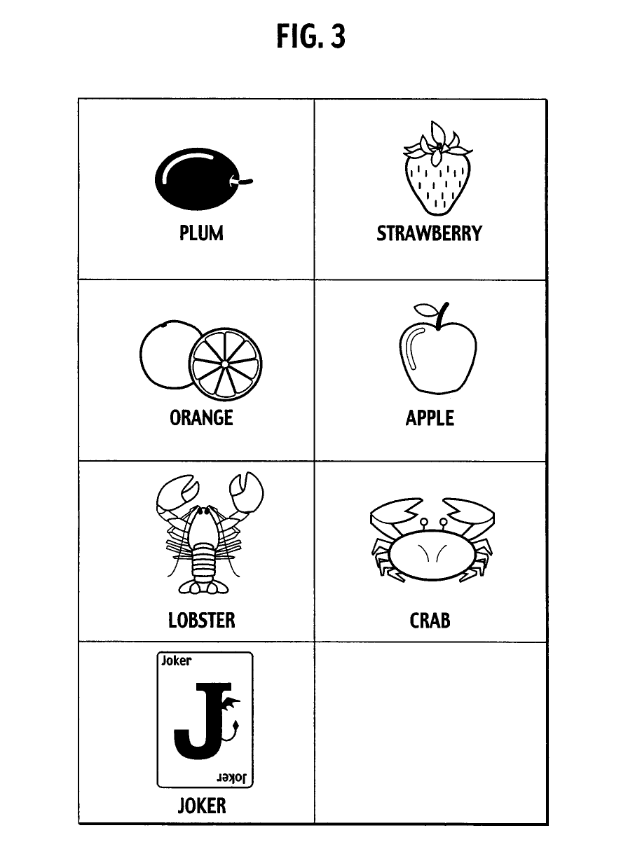

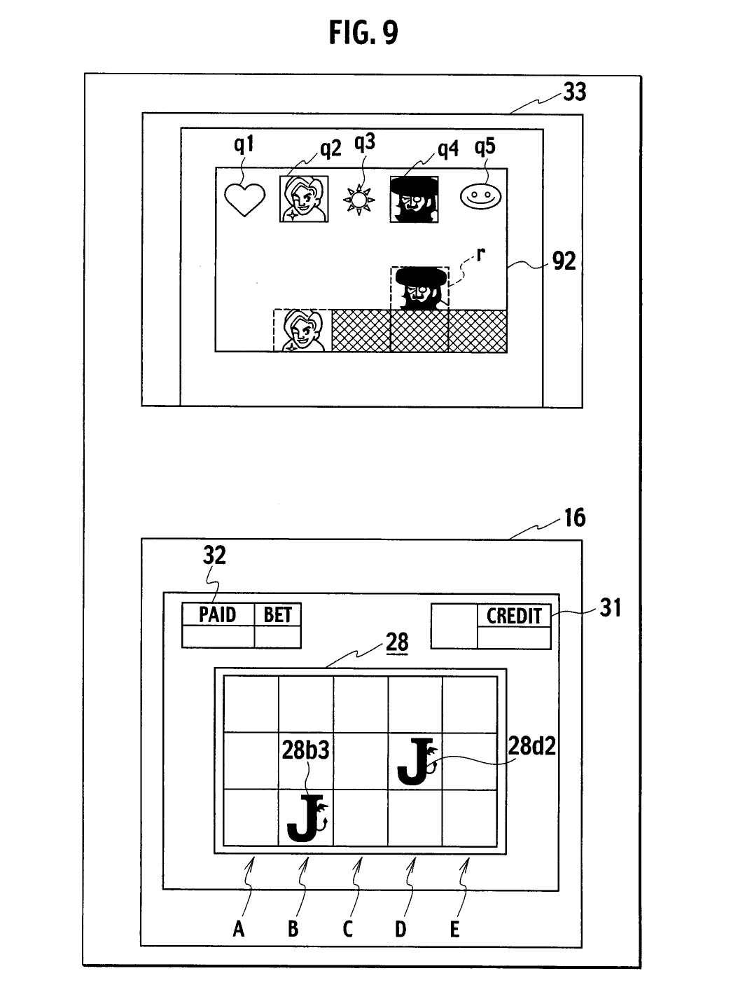

Next, the number of specific symbols stopped in each of the defined-area groups A to E is counted (Step S600). When the specific defined-area group is selected, processing of starting scrolling of symbols and, thereafter, stopping the symbols is executed. In this processing, it is determined whether or not a specific symbol, for example, a “JOKER” symbol shown in FIG. 3 is stopped in any of the defined areas 28 (28a1 to 28e3) in the respective defined-area groups A to E. When the specific symbol is stopped, a count value is incremented in any of the defined-area groups A to E to which the defined area to be a stop position belongs. For example, as shown in FIG. 9, one block image r is stacked and displayed in a count number display part 92 corresponding to the defined-area group in which the specific symbol is stopped. Specifically, in the count number display part 92, character images q1 to q5 corresponding to the respective defined-area groups A to E are displayed and the block images r are to be displayed therebelow. When the “JOKER” symbols are stopped in the respective defined-area groups A to E, the block images r are stacked and displayed below the respective character images q1 to q5.

Here, the count number is set to be incremented when the specific symbol is stopped in each of the defined-area groups in one bonus game. However, the count number may be set to be incremented according to the number of the specific symbols stopped in each of the defined-area groups. In this case, when a plurality of specific symbols are stopped in the same defined-area group in one bonus game, a count value is added for the number of the specific symbols stopped.

Thereafter, according to the count value in the specific defined-area group, a payout (an award) to the player is determined (Step S700). For example, the following mode is set. Specifically, the defined-area groups compete for the order in which the block images r in the count number display part 92 reach a predetermined number (for example, 3) as the execution of the bonus game advances. Thus, the payout (the award) is determined according to where the specific defined-area group is ranked. To be more specific, when the specific defined-area group is ranked in the fifth place as to the order in which the block images r in the count number display part 92 corresponding to the specific defined-area group reach the predetermined number, 10 coins are paid out. Similarly, 20 coins are paid out when the specific defined-area group is ranked in the fourth place, 30 coins are paid out when the specific defined-area group is ranked in the third place, 50 coins are paid out when the specific defined-area group is ranked in the second place, and 100 coins are paid out when the specific defined-area group is ranked in the first place.

Next, processing of paying out the number of coins determined by the above processing is performed (Step S800). Thus, the game is executed in the slot machine according to the embodiment of the present invention.

Next, with reference to the perspective view shown in FIG. 2, description will be given of a configuration of a slot machine 10 according to the embodiment of the present invention.

The slot machine 10 is placed in a game arcade. In the slot machine 10, coins, bills or valuable electronic information equivalent thereto are used as game media for executing the basic game. Note, however, that the game media are not particularly limited in the present invention. For example, medals, tokens, electronic money and tickets can be cited. The tickets described above are not particularly limited. For example, bar-coded tickets as described later and the like can be cited.

As shown in FIG. 2, the slot machine 10 includes the cabinet 11, a top box 12 provided on the cabinet 11, and a main door 13 provided on the front surface of the cabinet 11.

An upper image-display-panel 33 is provided in an upper part of the cabinet 11, and a lower image-display-panel 16 is provided in a middle part of the cabinet 11. A rectangular display window 15 is provided approximately in the center of the lower image-display-panel 16. Inside of the display window 15, a liquid crystal display unit (display) 17 is provided. The liquid crystal display unit 17 is divided into 5 columns×3 rows, a total of 15 defined areas 28 (28a1 to 28e3) (see FIG. 11). Accordingly, when a basic game is executed, symbols are scroll-displayed in the respective defined areas 28 (28a1 to 28e3) in the liquid crystal display unit 17. Moreover, the scroll-displayed symbols are made visible to the player through the display window 15.

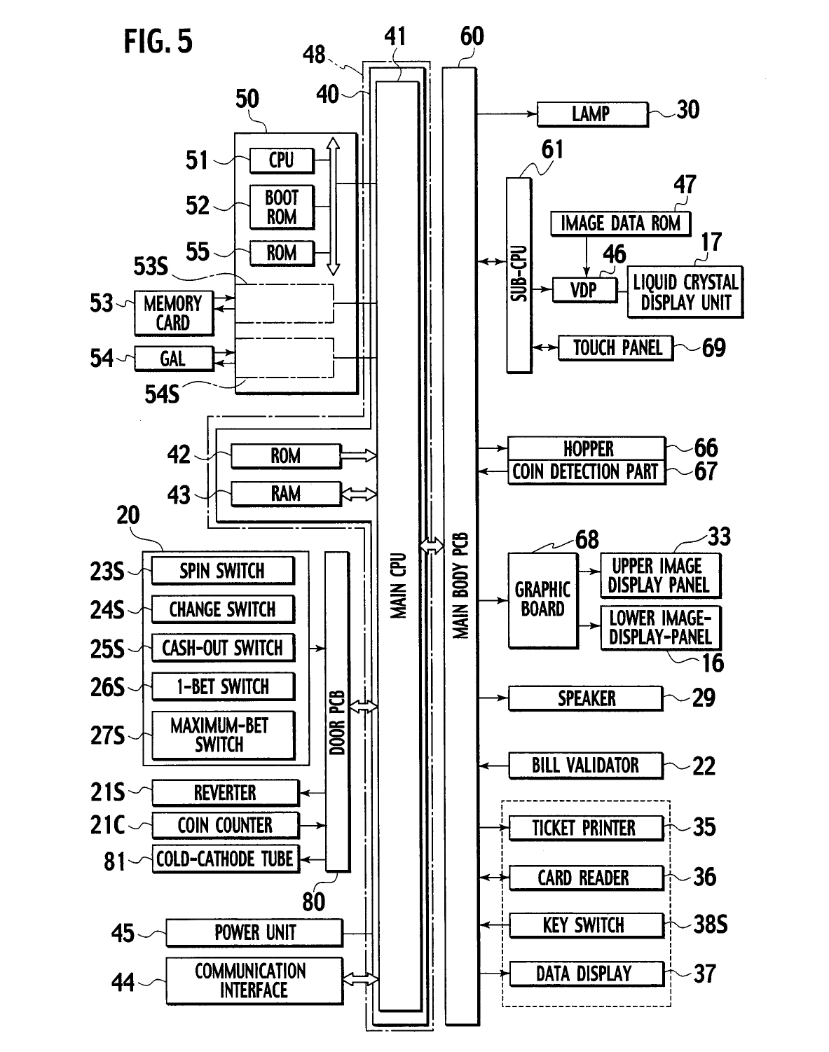

On a surface of the display window 15 on the front side of the liquid crystal display unit 17, a touch panel 69 (see FIG. 5) is provided. The touch panel 69 is divided so as to correspond to the fifteen defined areas 28 (28a1 to 28e3). Accordingly, when the touch panel 69 is touched by the player, a position touched by the player can be identified having each of the defined areas 28 as a unit.

In this embodiment, description will be given of the example of using the liquid crystal display unit 17 having the defined areas 28 in 5 columns×3 rows as the display. However, the defined areas are not limited to 5 columns×3 rows. Instead of the liquid crystal display unit 17, it is also possible to adopt a configuration using a mechanical rotating reel to display symbols. In this case, the rotating reel serves as the display.

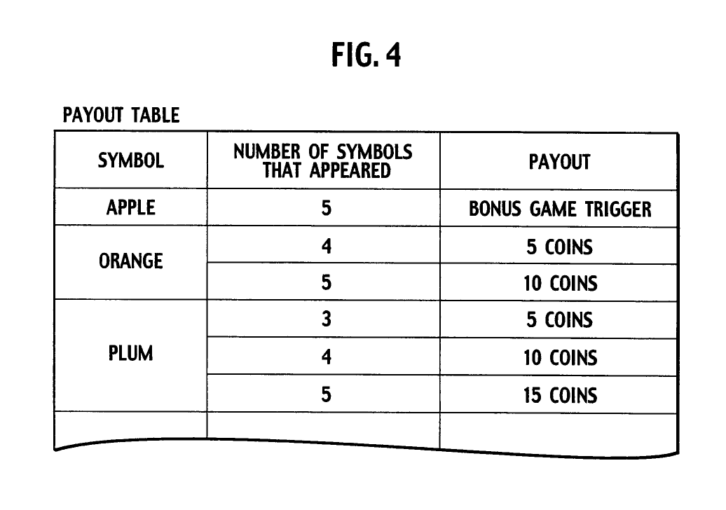

The lower image-display-panel 16 includes a transparent liquid crystal panel and displays various information about games, effect images and the like during the games. In the lower image-display-panel 16, a credit number display part 31 and a payout number display part 32 are provided. In the credit number display part 31, the number of coins credited is displayed by an image. In the payout number display part 32, a relationship between the number of symbols and the number of coins to be paid out shown in FIG. 4 and the like are displayed by images.

Below the lower image-display-panel 16, provided are: a control panel 20 including a plurality of buttons 23 to 27 used by the player to input instructions related to a game process; the coin receiving port 21 for receiving coins into the cabinet 11; and a bill validator 22.

In the control panel 20, the spin button 23, a change button 24, a cash-out button 25, a 1-BET button 26 and a maximum-BET button 27 are provided. The spin button 23 is a button for inputting an instruction to start scrolling the symbols displayed in the respective defined areas 28 (28a1 to 28e3). The change button 24 is a button used to request money exchange to a staff member at the game arcade. The cash-out button 25 is a button for inputting an instruction to pay out credited coins onto a coin tray 18.

The 1-BET button 26 is a button for inputting an instruction to bet one of the credited coins on a game. The maximum-BET button 27 is a button for inputting an instruction to bet the maximum number (for example, 3) of coins that can be bet on one game out of the credited coins on the game.

The bill validator 22 validates whether or not bills are legitimate and accepts the legitimate bills into the cabinet 11. The bill validator 22 may be configured to be able to read a bar-coded ticket 39 to be described later. On a front surface of a lower part of the main door 13, in other words, below the control panel 20, a belly glass 34 is provided, on which characters of the slot machine 10 and the like are drawn.

On a front surface of the top box 12, the upper image-display-panel 33 is provided. The upper image-display-panel 33 has a graphic board 68 and displays, for example, effect images and images representing introduction of game contents and description of game rules. The graphic board 68 serves as the count number display part 92 which displays the number of times the specific symbol, for example, the “JOKER” symbol to be described later is displayed in each of the defined-area groups A to E when the bonus game is executed as shown in FIG. 9. Specifically, the defined-area groups are set by dividing the fifteen defined areas 28 (28a1 to 28e3) into the respective columns.

In the top box 12, a speaker 29 for audio output and a lamp 30 are provided. Below the upper image-display-panel 33, a ticket printer 35, a card reader 36, a data display 37 and a keypad 38 are provided. The ticket printer 35 prints a bar-code on a ticket, the bar-code having coded data such as the number of credits, time and date and an identification number of the slot machine 10, and outputs the ticket as the bar-coded ticket 39. The player can use the bar-coded ticket 39 to play other slot machines or change the bar-coded ticket 39 for bills and the like at a cashier or the like in the game arcade.

The card reader 36 reads data from a smart card and writes data into the smart card. The smart card is a card carried by the player and stores, for example, data for identifying the player and data on a history of games played by the player.

The data display 37 is formed of a fluorescent display or the like and displays, for example, the data read by the card reader 36 and data inputted by the player using the keypad 38. The keypad 38 is used to input instructions or data for ticketing and the like.

FIG. 3 is an explanatory view showing symbols which are scroll-displayed in the respective defined areas 28 (28a1 to 28e3) in the liquid crystal display unit 17, and which are then stop-displayed. As shown in FIG. 3, respective “PLUM”, “ORANGE”, “STRAWBERRY”, “APPLE”, “LOBSTER” and “CRAB” symbols are scroll-displayed. As described later, the “JOKER” symbol is scroll-displayed in addition to the respective symbols described above when a bonus trigger is established and a bonus game is executed.

FIG. 4 is an explanatory view showing a payout table in which symbols stopped in the respective defined areas 28 (28a1 to 28e3) and the number of coins to be paid out to the player are set during the execution of the basic game. As shown in FIG. 4, when five “APPLE” symbols are stopped in the fifteen defined areas 28 (28a1 to 28e3), a bonus trigger is established and a bonus game is executed.

When four “ORANGE” symbols are stopped, 5 coins are paid out. Moreover, when five “ORANGE” symbols are stopped, 10 coins are paid out. When three “PLUM” symbols are stopped, 5 coins are paid out. Moreover, when four “PLUM” symbols are stopped, 10 coins are paid out. Furthermore, when five “PLUM” symbols are stopped, 15 coins are paid out.

FIG. 5 is a block diagram showing an internal configuration of the slot machine shown in FIG. 2. A gaming board 50 includes: a CPU (Central Processing Unit) 51, a ROM 55 and a boot ROM 52, which are connected to each other through an internal bus; a card slot 53S compatible with a memory card 53; and an IC socket 54S compatible with a GAL (Generic Array Logic) 54.

The memory card 53 is formed of a nonvolatile memory and stores game programs. The game programs include a symbol determination program. The symbol determination program is a program for determining symbols (code numbers corresponding to the symbols) to be stop-displayed in the respective defined areas 28.

The card slot 53S is formed so as to enable the memory card 53 to be inserted thereinto or removed therefrom, and is connected to the mother board 40 through an IDE bus. Accordingly, the kinds and contents of games played by use of the slot machine 10 can be changed by removing the memory card 53 from the card slot 53S, writing another game program into the memory card 53 and inserting the memory card 53 into the card slot 53S. The game program contains a program related to a game process and also contains image data and sound data which are outputted during games.

The CPU 51, the ROM 55 and the boot ROM 52, which are connected to each other through the internal bus, are connected to the mother board 40 through a PCI bus. The PCI bus transmits signals between the mother board 40 and the gaming board 50 and also supplies power from the mother board 40 to the gaming board 50. A controller 48 consists of the mother board 40 and the gaming board 50.

The mother board 40 is formed by use of a commercially available general-purpose mother board (a printed wiring board on which basic components of a personal computer are mounted) and includes a main CPU 41, a ROM (Read Only Memory) 42, a RAM (Random Access Memory) 43 and a communication interface 44.

The ROM 42 is formed of a memory device such as a flash memory, and stores a program such as a BIOS (Basic Input/Output System) executed by the main CPU 41 and also data to be permanently used. When the BIOS is executed by the main CPU 41, predetermined peripheral devices are initialized. Moreover, read processing through the gaming board 50 is started for the game program stored in the memory card 53. In this invention, the ROM 42 may be a rewritable one or may be a non-rewritable one.

The RAM 43 stores data and programs used when the main CPU 41 is operated. The RAM 43 can store the game program.

The RAM 43 stores data such as the number of credits and the number of coins to be thrown in or to be paid out in one game.

A main body PCB (Printed Circuit Board) 60 and a door PCB 80, which will be described later, are connected to the mother board 40 through USBs (Universal Serial Bus), respectively. A power unit 45 is connected to the mother board 40.

A device or an apparatus which generates an input signal to be inputted to the main CPU 41 and a device or an apparatus having operations controlled by a control signal outputted from the main CPU 41 are connected to the main body PCB 60 and the door PCB 80. The main CPU 41 performs predetermined arithmetic processing by executing the game program stored in the RAM 43 according to the input signal inputted to the main CPU 41 and stores a result thereof in the RAM 43. The main CPU 41 also transmits the control signal to the respective devices or apparatuses as control processing for the respective devices or apparatuses.

The lamp 30, the sub-CPU 61, a hopper 66, a coin detection part 67, the graphic board 68, the speaker 29, the bill validator 22, the ticket printer 35, the card reader 36, a key switch 38S and the data display 37 are connected to the main body PCB 60. The lamp 30 is lighted in a predetermined pattern according to a control signal outputted from the main CPU 41.

The sub-CPU 61 is connected to a VDP (Video Display Processor) 46 and the touch panel 69. The VDP 46 reads image data of symbols stored in an image data ROM 47, generates images to be displayed in the respective defined areas 28 (28a1 to 28e3) in the liquid crystal display unit 17, and outputs the image data to the liquid crystal display unit 17.

The touch panel 69 is provided on the surface of the display window 15 shown in FIG. 2 and detects a contact position when the player touches the touch panel 69 while the touch panel 69 is activated. Specifically, the player can arbitrarily select one of the defined areas 28 by touching the touch panel 69 at a position corresponding to each of the fifteen defined areas 28 (28a1 to 28e3).

The hopper 66 is placed in the cabinet 11 and pays out a predetermined number of coins from a coin payout opening 19 onto the coin tray 18 according to a control signal outputted from the main CPU 41. The coin detection part 67 is provided inside the coin payout opening 19 and outputs an input signal to the main CPU 41 when detecting that the predetermined number of coins are paid out from the coin payout opening 19.

The graphic board 68 controls image display on the upper and lower image-display-panels 33 and 16 according to a control signal outputted from the main CPU 41. The credit number display part 31 in the lower image-display-panel 16 displays the number of credits stored in the RAM 43. Moreover, the payout number display part 32 in the lower image-display-panel 16 displays the number of coins to be paid out. Furthermore, when a bonus game is executed, the count number display part 92 shown in FIG. 9 is displayed on the upper image-display-panel 33.

The graphic board 68 includes: a VDP (Video Display Processor) which generates image data according to a control signal outputted from the main CPU 41; a video RAM which temporarily stores the image data generated by the VDP; and the like. The game program read from the memory card 53 and stored in the RAM 43 contains image data used when the image data is generated by the VDP.

The bill validator 22 validates whether or not bills are legitimate and accepts the legitimate bills into the cabinet 11. Upon acceptance of the legitimate bills, the bill validator 22 outputs an input signal to the main CPU 41 according to an amount of the bills. Thereafter, the main CPU 41 stores in the RAM 43 the number of credits corresponding to the amount of the bills transmitted by the input signal.

The ticket printer 35 prints a bar-code on a ticket according to a control signal outputted from the main CPU 41, the bar-code having coded data such as the number of credits stored in the RAM 43, time and date and the identification number of the slot machine 10, and outputs the ticket as the bar-coded ticket 39.

The card reader 36 reads data from a smart card and transmits the data to the main CPU 41, and also writes data into the smart card according to a control signal from the main CPU 41. The key switch 38S is provided in the keypad 38 and outputs a predetermined input signal to the main CPU 41 when the keypad 38 is operated by the player. According to a control signal outputted from the main CPU 41, the data display 37 displays the data read by the card reader 36 and data inputted by the player using the keypad 38.

The control panel 20, a reverter 21S, a coin counter 21C and a cold-cathode tube 81 are connected to the door PCB 80. In the control panel 20, a spin switch 23S corresponding to the spin button 23, a change switch 24S corresponding to the change button 24, a cash-out switch 25S corresponding to the cash-out button 25, a 1-BET switch 26S corresponding to the 1-BET button 26 and a maximum-BET switch 27S corresponding to the maximum-BET button 27 are provided. Each of the switches 23S to 27S outputs an input signal to the main CPU 41 when the corresponding buttons 23 to 27 are operated by the player.

The coin counter 21C is provided inside the coin receiving port 21 and validates whether or not coins thrown into the coin receiving port 21 by the player are legitimate. Those other than the legitimate coins are discharged from the coin payout opening 19. Upon detection of the legitimate coins, the coin counter 21C outputs an input signal to the main CPU 41.

The reverter 21S is operated according to a control signal outputted from the main CPU 41, and allocates the coins recognized as the legitimate coins by the coin counter 21C to a cash box (not shown) or to the hopper 66 provided in the slot machine 10. Specifically, when the hopper 66 is filled with coins, the legitimate coins are allocated to the cash box by the reverter 21S. Meanwhile, when the hopper 66 is not filled with coins, the legitimate coins are allocated to the hopper 66. The cold cathode tube 81 functions as a backlight provided on the back side of the upper and lower image-display-panels 33 and 16, and is lighted according to a control signal outputted from the main CPU 41.

Next, processing executed in the slot machine 10 will be described. The main CPU 41 makes the game proceed by reading and executing the game program.

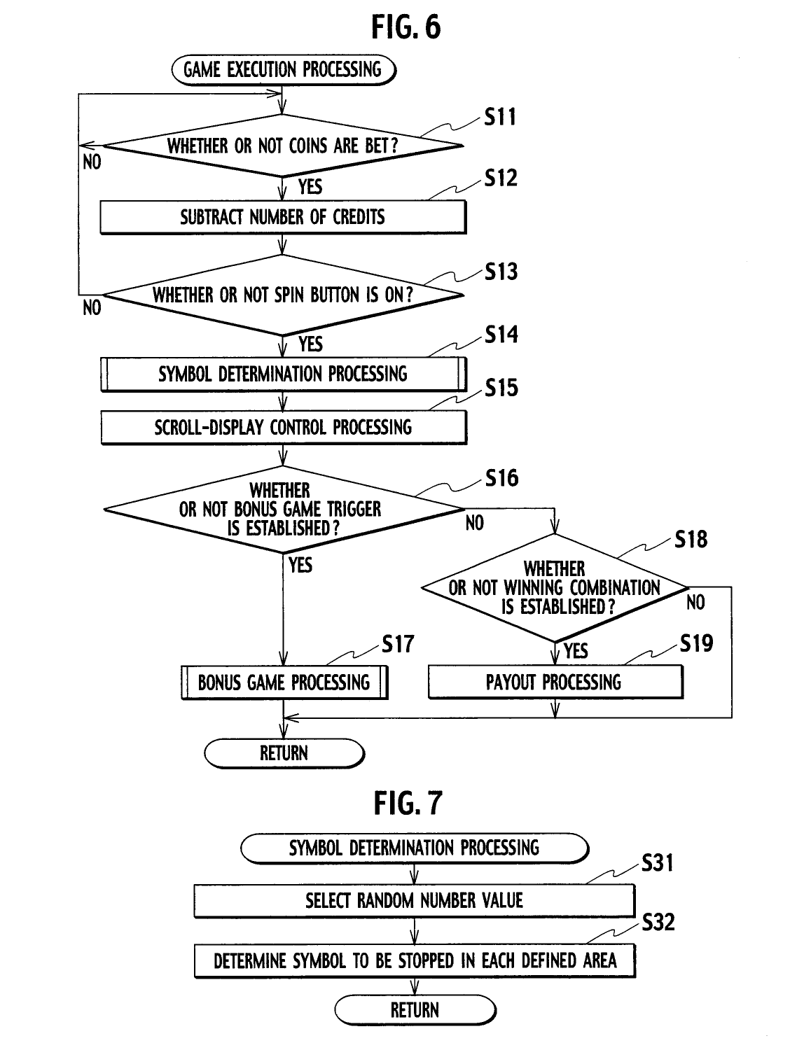

FIG. 6 is a flowchart showing game execution processing. In the game execution processing, first, the main CPU 41 determines whether or not coins are bet (Step S11). In this processing, the main CPU 41 determines whether or not an input signal outputted from the 1-BET switch 26S when the 1-BET button 26 is pressed or an input signal outputted from the maximum-BET switch 27S when the maximum-BET button 27 is pressed is received. When it is determined that no coins are bet, the processing returns to Step S11.

Meanwhile, when it is determined in Step S11 that the coins are bet, the main CPU 41 performs processing of reducing the number of credits stored in the RAM 43 according to the number of the coins bet (Step S12). When the number of the coins bet is larger than the number of credits stored in the RAM 43, the processing returns to Step S11 without performing the processing of reducing the number of credits stored in the RAM 43. When the number of the coins bet exceeds an upper limit (for example, 3) that can be bet in one game, the processing advances to Step S13 without performing the processing of reducing the number of credits stored in the RAM 43.

In Step S13, the main CPU 41 determines whether or not the spin button 23 is turned on. In this processing, the main CPU 41 determines whether or not an input signal outputted from the spin switch 23S when the spin button 23 is pressed is received.

When it is determined that the spin button 23 is not turned on, the processing returns to Step S11. In the case where the spin button 23 is not turned on (for example, the case where an instruction to finish the game is inputted without turning on the spin button 23), the main CPU 41 cancels a result of reduction in Step S12.

Meanwhile, when it is determined in Step S13 that the spin button 23 is turned on, the main CPU 41 performs symbol determination processing (Step S14). In the symbol determination processing, the main CPU 41 determines code numbers when the symbols are stopped by executing the symbol determination program stored in the RAM 43. This processing will be described in detail later with reference to FIG. 7. In this embodiment, description will be given of the case where one or more winning combinations are determined among several kinds of winning combinations by determining symbols to be stop-displayed. However, the present invention is not limited to the above case. For example, one or more winning combinations may be first determined among several kinds of winning combinations, and then a combination of symbols to be stop-displayed may be determined according to the one or more winning combinations determined.

Next, the main CPU 41 performs scroll-display control processing for the respective defined areas 28 (28a1 to 28e3) in the liquid crystal display unit 17 (Step S15). In this processing, display control is performed so that the symbols determined in Step S14 are stop-displayed after scrolling of the symbols is started.

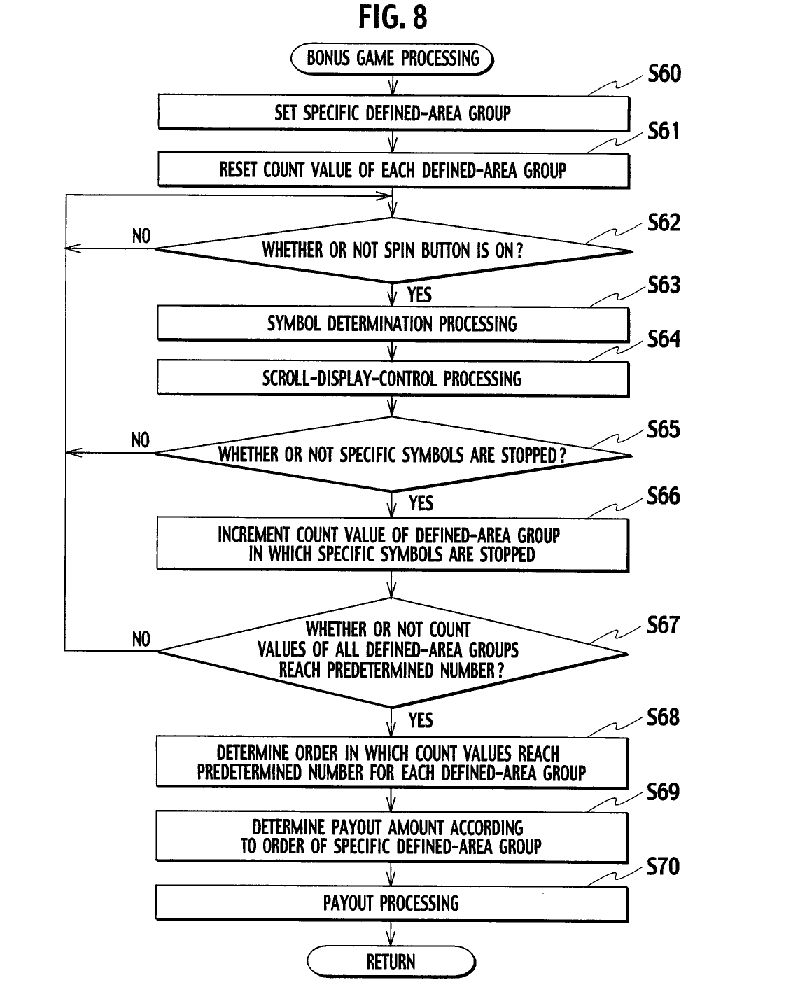

Thereafter, the main CPU 41 determines whether or not a bonus game trigger is established, in other words, whether or not five or more “APPLE” symbols to be the bonus game trigger are stopped in the fifteen defined areas 28 (28a1 to 28e3) (Step S16). When it is determined that the bonus game trigger is established, the main CPU 41 executes bonus game processing by reading a program for executing a bonus game from the RAM 43 (Step S17), and finishes this subroutine. The bonus game processing will be described in detail later with reference to FIG. 8.

When it is determined that the bonus game trigger is not established (NO in Step S16), the main CPU 41 determines whether or not a winning combination is established (Step S18). Formation of the winning combination is determined by the number of scatter symbols to be stopped in the fifteen defined areas 28 (28a1 to 28e3) or by a combination of specific symbols to be stopped on a payline. For example, as shown in FIG. 4, when four “ORANGE” symbols are stopped as the scatter symbols, 5 coins are paid out.

Thereafter, the main CPU 41 performs processing of paying out the coins (Step S19) and finishes this subroutine. Moreover, when no winning combination is established (NO in Step S18), this subroutine is finished.

FIG. 7 is a flowchart showing a subroutine of the stop-symbol determination processing executed in Step S14 shown in FIG. 6. This processing is performed by the main CPU 41 executing the symbol determination program stored in the RAM 43.

First, the main CPU 41 selects random number values corresponding to the respective symbols from a numeric range of 0 to 255 by executing a random number generation program included in the symbol determination program (Step S31). In this embodiment, description will be given of the case where random numbers are generated using the program (the case where so-called software random numbers are used). However, the present invention is not limited to the above case, but may be applied to the case where a random number generating circuit is provided, and random numbers are extracted from the random number generating circuit (so-called hardware random numbers are used).

Next, the main CPU 41 determines symbols to be stopped in the respective defined areas 28 (28a1 to 28e3) according to the selected random number values (Step S32).

FIG. 8 is a flowchart showing the subroutine of the bonus game processing executed in Step S17 shown in FIG. 6. In the bonus game processing, first, the main CPU 41 performs processing of setting a specific defined-area group among a plurality of defined-area groups set for the respective defined areas 28 (28a1 to 28e3) (Step S60). In this processing, the respective defined areas 28 (28a1 to 28e3) are divided into five columns of defined-area groups A to E. Thereafter, one of the columns is selected as the specific defined-area group by the player using the touch panel 69. Specifically, the respective defined areas 28a1 to 28a3, 28b1 to 28b3, 28c1 to 28c3, 28d1 to 28d3 and 28e1 to 28e3 divided into five columns are set as the defined-area groups A to E, respectively (see FIG. 9). When any one of the defined-area groups is selected by operating the touch panel 69, the selected defined-area group including the three defined areas 28 is set as the specific defined-area group. Moreover, the specific defined-area group is distinguished from the other defined-area groups, for example, by changing the background color or the like. Thus, the player is informed of which one of the defined-area groups is selected as the specific defined-area group.

Thereafter, processing of resetting a count value (a value indicating the number of times the “JOKER” symbol to be described later is stopped) which is set for each of the defined-area groups is performed (Step S61). Next, it is determined whether or not the spin button 23 is turned on (Step S62). When the spin button 23 is turned on, symbol determination processing is performed (Step S63) and scroll-display control processing is further performed (Step S64). Here, the symbol determination processing is the same as that in Step S14 shown in FIG. 6, and the scroll-display control processing is the same as that in Step S15 shown in FIG. 6. Thus, description thereof will be omitted. Note, however, that, in the scroll-display control processing in the bonus game, the “JOKER” symbol shown in FIG. 3 is scrolled.

Next, the main CPU 41 determines from a result of the scroll-display whether or not the “JOKER” symbol (specific symbol) is stopped in any of the defined areas 28 (28a1 to 28e3) (Step S65). When no “JOKER” symbol is stopped, the processing returns to Step S62.

When the “JOKER” symbol is stopped, it is determined which one of the defined-area groups A to E includes the defined area 28 in which the “JOKER” symbol is stopped, and the count value of this defined-area group is incremented (Step S66). At the same time, as shown in FIG. 9, one block image r is stacked and displayed in the corresponding defined-area group on the upper image-display-panel 33. Furthermore, the stacked block image r is displayed so as to operate the character image for a predetermined time. Thus, the player is informed of that the block image r is newly stacked.

Subsequently, when the count values of all the defined-area groups A to E reach a predetermined number (for example, “3”) (YES in Step S67) after the above processing is repeatedly executed, the order in which the count values of the respective defined-area groups have reached the predetermined number is determined (Step S68). Specifically, the respective defined-area groups A to E are ranked from the first to the fifth. As a result, the rank of the specific defined-area group set by the processing in Step S60 is determined.

Thereafter, the main CPU 41 determines a payout amount according to the rank of the specific defined-area group (Step S69). For example, the payout amount is set in the following manner. Specifically, in the case where the defined-area group C is set as the specific defined-area group and the specific defined-area group C is ranked in the fifth place as to the order in which the count values reach the predetermined number, 10 coins are paid out. Similarly, 20 coins are paid out when the specific defined-area group C is ranked in the fourth place, 30 coins are paid out when the specific defined-area group C is ranked in the third place, 50 coins are paid out when the specific defined-area group C is ranked in the second place, and 100 coins are paid out when the specific defined-area group C is ranked in the first place. In other words, the higher in the order in which the count values reach the predetermined number, the more coins are to be paid out.

Subsequently, processing of providing the payout amount described above is performed (Step S70). Thus, the bonus game is executed.

As described above, in the slot machine according to this embodiment, when the bonus game trigger is established in execution of the basic game and a shift is made to the bonus game, the number of times the “JOKER” symbol (specific symbol) is stopped in each of the defined-area groups A to E in more than one bonus game is counted. Thereafter, when the number of times the “JOKER” symbol is stopped reaches the predetermined number (for example, 3) for all the defined-area groups A to E, the bonus game is finished. Subsequently, the order in which the count values of the respective defined-area groups A to E have reached the predetermined number is determined. Moreover, for the specific defined-area group initially selected by the player, the payout amount is set in such a manner that the higher in the order in which the count values reach the predetermined number, the more coins are to be paid out.

Hence, when the bonus game is started, it is possible to allow the player to have interest in whether or not the “JOKER” symbol will be stopped in the defined-area group (for example, the defined-area group C) that he/she has selected. Accordingly, the player's interest in the games executed in the slot machine can be maintained.

The player himself/herself sets the specific defined-area group. Moreover, when the set defined-area group is ranked high as to the order in which the count values reach the predetermined number, the count value being the number of times the specific symbol is stopped, more coins are paid out. Thus, it is possible to give the player a feeling of satisfaction with the fact that he/she has made the right choice.

In the above embodiment, the description was given of the example where the respective defined-area groups are ranked from the one in which the number of bonus games, that is, the number of times the “JOKER” symbol as the specific symbol is stopped first reaches the predetermined number. Accordingly, even when a plurality of “JOKER” symbols are stopped in the defined areas 28 included in the same defined-area group in one bonus game, the count value is set to “1”. However, the present invention is not limited to the above case, but may be applied to the case where the number of the “JOKER” symbols stopped is counted. Specifically, when two “JOKER” symbols are stopped in the defined areas 28 included in the same defined-area group in one bonus game, the count value may be incremented by 2.

In the above embodiment, the description was given of the example where the player sets an arbitrary defined-area group among the five columns of defined-area groups A to E as the specific defined-area group. However, the specific defined-area group may be randomly determined under the control of the main CPU 41. Moreover, the same defined-area group (for example, the defined-area group C) may be always set as the specific defined-area group.

In the above embodiment, the description was given of the example where the bonus game is continued until, for all the defined-area groups A to E, the count value that is the number of times the specific symbol is stopped reaches the predetermined number (for example, 3). However, the bonus game may be finished when the count value of any one of the defined-area groups reaches the predetermined number. In this case, the payout amount is changed between the case where the count value of the specific defined-area group reaches the predetermined number and the case where the bonus game is finished before the count value of the specific defined-area group reaches the predetermined number.

It is also possible to adopt a configuration in which the number of bonus games is previously determined (for example, 20) and a payout amount is changed according to a count value when the determined number of bonus games is finished.

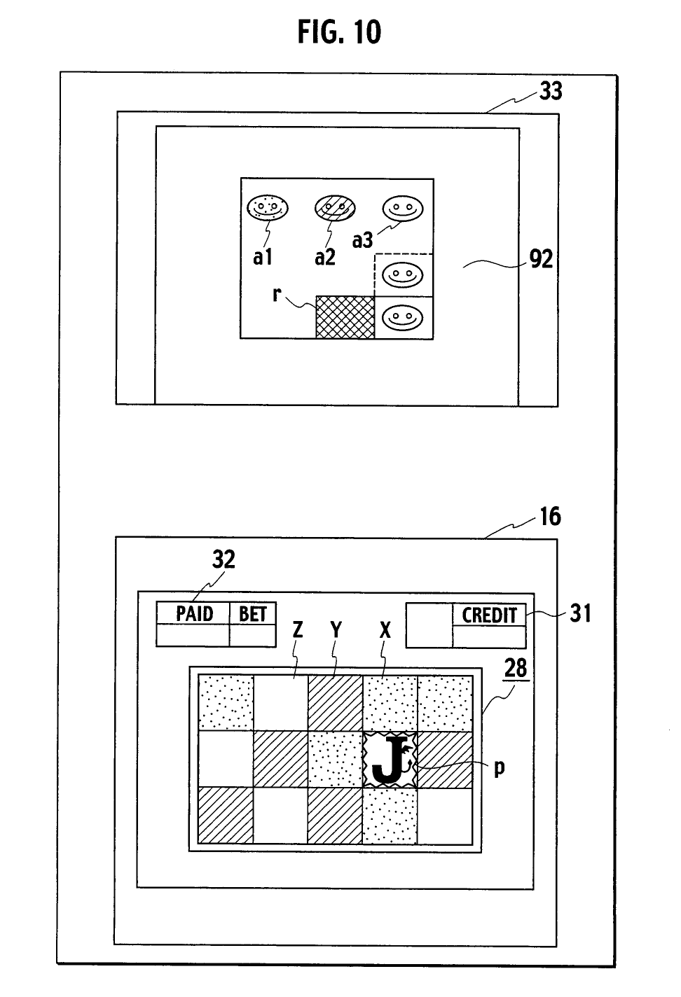

Next, a modified example of the embodiment of the present invention will be described. In the above embodiment, the description was given of the example where the defined areas 28 arranged in the matrix pattern consisting of 5 columns×3 rows are divided into five columns and the respective columns are set as the defined-area groups A to E. Meanwhile, in the modified example, the fifteen defined areas 28 (28a1 to 28e3) are randomly divided into a plurality of defined-area groups. To be more specific, as shown in FIG. 10, when a bonus game is started, defined-area groups X, Y and Z are set, each of which includes five defined areas 28 randomly selected from the fifteen defined areas 28 (28a1 to 28e3). Moreover, the respective defined-area groups X, Y and Z are displayed in different background colors such as red, blue and yellow. Thus, the player can recognize which one of the defined areas 28 belongs to which one of the defined-area groups X, Y and Z.

Subsequent procedures are the same as those in the flowchart shown in FIG. 8. Specifically, any one of the defined-area groups X, Y and Z is selected by the player, and the selected defined-area group is set as a specific defined-area group.

As shown in FIG. 10, in the count number display part 92 on the upper image-display-panel 33, character images a1 (red), a2 (blue) and a3 (yellow) are displayed in three colors. The character image a1 corresponds to the defined-area group X, the character image a2 corresponds to the defined-area group Y, and the character image a3 corresponds to the defined-area group Z. Accordingly, when a “JOKER” symbol, a specific symbol, is stopped in the defined-area group X, one block image r is displayed below the character image a1. Similarly, when the “JOKER” symbol, the specific symbol, is stopped in the defined-area group Y, one block image r is displayed below the character image a2. Moreover, when the “JOKER” symbol, the specific symbol, is stopped in the defined-area group Z, one block image r is displayed below the character image a3. The bonus game is executed until the total number of the block images r for all the character images reaches a predetermined number (for example, 3). Thus, the respective defined-area groups X, Y and Z are ranked from the one for which the number of the block images first reaches the predetermined number.

As a result, a payout amount is determined according to the rank of the specific defined-area group (for example, the defined-area group Y).

In this modified example, a high-multiplying-factor defined area p is randomly set among the defined areas 28 (28a1 to 28e3) under the control of the main CPU 41. The set high-multiplying-factor defined area p is displayed with its surrounding brightly lighted as shown in FIG. 10. Thus, the player is informed of that the bright area is the high-multiplying-factor defined area p.

When the “JOKER” symbol, the specific symbol, is stopped in the high-multiplying-factor defined area p, the number of times the “JOKER” symbol is stopped is counted as 2. In other words, the number of block images is increased by 2 at a time.

As described above, in the slot machine according to this modified example, the respective defined areas 28 (28a1 to 28e3) are randomly divided to set the plurality of defined-area groups. Thus, it is possible to allow the player to have strong interest in a position where the specific symbol is to be stopped. When the specific symbol is stopped in the high-multiplying-factor defined area p, the number of times the specific symbol is stopped is counted as 2 in one stop. Thus, it is possible to allow the player to have strong interest in whether or not the specific symbol will be stopped in the high-multiplying-factor defined area p. Moreover, the player's interest in the games played in the slot machine can be maintained.

In the above modified example, the description was given of the example where, when the specific symbol is stopped in the high-multiplying-factor defined area p, the number of times the specific symbol is stopped is counted as 2. However, the present invention is not limited thereto, but can also be applied to the case where the number of times the specific symbol is stopped is counted as 3 or more.

In the embodiment and the modified example, the description was given of the example where the liquid crystal display unit 17 is used as the display. However, instead of the liquid crystal display unit 17, other displays, such as a CRT display and a plasma display, can also be used.

The slot machine and the method for playing the slot machine according to the embodiment of the present invention make it possible to improve the ability to pull in more customers and to make it more entertaining.

Although the slot machine and the method for playing a slot machine according to the embodiment of the present invention have been described above with the embodiment shown in the drawings, the present invention is not limited thereto. The configurations of the respective parts can be replaced with arbitrary configurations having the same functions.

The invention may be embodied in other specific forms without departing from the spirit or essential characteristics thereof. The present embodiment is therefore to be considered in all respects as illustrative and not restrictive, the scope of the invention being indicated by the appended claims rather than by the foregoing description and all changes which come within the meaning and range of equivalency of the claims are therefore intended to be embraced therein.

What is claimed is:

1. A slot machine comprising:
a display having a plurality of defined areas in a matrix pattern consisting of a plurality of columns and rows, and adapted to rearrange symbols arranged in the respective defined areas; and
a controller configured to
(a) set a plurality of defined-area groups each including at least one of the plurality of defined areas,
(b) count, for each of the defined-area groups, any one of the number of bonus games in which a specific symbol is rearranged in the defined-area groups and the number of specific symbols rearranged in the defined-area groups, in bonus games shifted from a basic game, and
(c) provide a payout to a player according to the counted number for a specific defined-area group among the defined-area groups.

2. A slot machine comprising:
a display having a plurality of defined areas in a matrix pattern consisting of a plurality of columns and rows, and adapted to rearrange symbols arranged in the respective defined areas; and
a controller configured to
(a) set a plurality of defined-area groups each including at least one of the plurality of defined areas,
(b) count, for each of the defined-area groups, any one of the number of bonus games in which a specific symbol is rearranged in the defined-area groups and the number of the specific symbols rearranged in the defined-area groups, in bonus games shifted from a basic game,
(c) determine an order in which each of the counted numbers reaches a predetermined number for the defined-area groups, and
(d) provide a higher payout to a player when the order for a specific defined-area group among the defined-area groups is higher.

3. A slot machine comprising:
a display having a plurality of defined areas in a matrix pattern consisting of a plurality of columns and rows, and adapted to rearrange symbols arranged in the respective defined areas; and
a controller configured to
(a) set a plurality of defined-area groups each including at least one of the plurality of defined areas,
(b) count, for each of the defined-area groups, any one of the number of bonus games in which a specific symbol is rearranged in the defined-area groups and the number of specific symbols rearranged in the defined-area groups, in bonus games shifted from a basic game,
(c) set at least one of the defined areas as a high-multiplying-factor defined area,
(d) set a counted number for the defined-area group including the high-multiplying-factor defined area so as to be larger than that in a normal time when the specific symbol is rearranged in the high-multiplying-factor defined area,
(e) determine an order in which each of the counted numbers reaches a predetermined number for the defined-area groups, and
(f) provide a higher payout to a player when the order for a specific defined-area group among the defined-area groups is higher.

4. The slot machine according to any one of claims 1 to 3, wherein the controller sets the specific defined-area group according to an external input.

5. The slot machine according to any one of claims 1 to 3, wherein each of the defined-area groups consists of the defined areas in any one of the same column and the same row.

6. A method for playing a slot machine, comprising the steps of:
(a) rearranging symbols arranged in a display, in bonus games shifted from a basic game, the display having a plurality of defined areas in a matrix pattern consisting of a plurality of columns and rows and having a plurality of defined-area groups set in the display, each of the defined-area groups including at least one of the plurality of defined areas,
(b) counting, for each of the defined-area groups, any one of the number of bonus games in which a specific symbol is rearranged in the defined-area groups and the number of the specific symbols rearranged in the defined-area groups, and
(c) providing a payout to a player according to the counted number for a specific defined-area group among the defined-area groups.

7. A method for playing a slot machine, comprising the steps of:
(a) rearranging symbols arranged in a display, in bonus games shifted from a basic game, the display having a plurality of defined areas provided in a matrix pattern consisting of a plurality of columns and rows and having a plurality of defined-area groups set in the display, each of the defined-area groups including at least one of the plurality of defined areas,
(b) counting, for each of the defined-area groups, any one of the number of bonus games in which a specific symbol is rearranged in the defined-area groups and the number of the specific symbols rearranged in the defined-area groups,
(c) determining an order in which each of the counted numbers reaches a predetermined number for the defined-area groups, and
(d) providing a higher payout to a player when the order for a specific defined-area group among the defined-area groups is higher.

8. A method for playing a slot machine, comprising the steps of:
(a) rearranging symbols arranged in a display, in bonus games shifted from a basic game, the display having a plurality of defined areas provided in a matrix pattern consisting of a plurality of columns and rows and having a plurality of defined-area groups set therein, each of the defined-area groups including at least one of the plurality of defined areas,
(b) counting, for each of the defined-area groups, any one of the number of bonus games in which a specific symbol is rearranged in the defined-area groups and the number of the specific symbols rearranged in the defined-area groups,
(c) setting at least one of the defined areas as a high-multiplying-factor defined area,
(d) setting a counted number for the defined-area group including the high-multiplying-factor defined area so as to be larger than that in a normal time when the specific symbol is rearranged in the high-multiplying-factor defined area,
(e) determining an order in which each of the counted number reaches a predetermined number for the defined-area groups, and
(f) providing a higher payout to a player when the order for a specific defined-area group among the defined-area groups is higher.

9. The method for playing a slot machine, according to any one of claims 6 to 8, further comprising the step of setting the specific defined-area group according to an external input.

10. The method for playing a slot machine, according to any one of claims 6 to 8, further comprising the step of setting each of the defined-area groups consisting of the defined areas provided in any one of the same column and the same row.
